(19) United States
(12) Patent Application Publication
(10) Pub. No.: US 2008/0262847 A1
(43) Pub. Date: Oct. 23, 2008

(54) USER POSITIONABLE AUDIO ANCHORS FOR DIRECTIONAL AUDIO PLAYBACK FROM VOICE-ENABLED INTERFACES

(75) Inventors: Ciprian Agapi, Lake Worth, FL (US); Oscar J. Blass, Boynton Beach, FL (US); Paritosh D. Patel, Parkland, FL (US); Roberto Vila, Hollywood, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/737,437

(22) Filed: Apr. 19, 2007

(51) Int. Cl. G10L 21/00; G06F 3/041

(52) U.S. Cl. 704/275; 340/407.1; 345/173

(57) ABSTRACT

The present invention discloses a concept and a use of audio anchors within voice-enabled interfaces. Audio anchors can be user configurable points from which audio playback occurs. In the invention, a user can identify an interface position at which an audio anchor is to be established. The computing device can determine an anchor direction setting, with values that include forward playback and backward playback. Interface items can then be audibly enumerated from the audio anchor in a direction indicated by the anchor direction setting. For example, if a set of interface items are alphabetically ordered items and if an audio anchor is set at a first item beginning with a letter “G” and an anchor direction is set to indicate backward playback, then the interface items beginning with letters “A-F” can be audibly played in reverse alphabetical order. Additionally, a rate of audio playback can be user adjustable.

### BACKGROUND

1. Field of the Invention

The present invention relates to the field of computing device interfaces and, more particularly, to user positional anchors for directional, user controlled audio playback from voice-enabled interfaces.

2. Description of the Related Art

Voice-enabled interfaces are able to accept and process speech input and/or to produce speech output. Voice-enabled interfaces are particularly advantageous for interacting with mobile and embedded computing devices which often have limited input/output peripherals due to their compact size and/or restrictions of their intended operational environment. Speech based interactions can be highly advantageous in situations where a device user is performing one or more tasks that require focused attention (e.g., driving or walking). For instance, media playing mobile devices and/or mobile telephones can be potentially dangerous when they require a user to look at a LCD screen and to manipulate selection controls with their hands. Despite this potential danger, visual and tactile based controls remain the most commonly implemented and used interactive mechanisms for mobile computing devices.

One reason that visual/tactile interactions remain predominant is that conventional voice-enabled interface controls are cumbersome to use in many common, re-occurring situations. For example, a device that audibly enumerates long playlists of selectable songs can quickly try a user's patience. Indexing a large set of songs by artist, album, and/or customizable playlists and then audibly presenting organized subsets of songs mitigates the problem to some extent and in some instances, but fails to resolve underlying systemic flaws.

For instance, hard drive equipped music playing devices can include hundreds of songs by a user preferred artist so that audibly enumerating available songs by the preferred artist results in too many entries for a user's comfort. In contrast, a user is able to quickly identify a desired song from a complete list of songs presented upon a scrollable visual display. What is needed is a new mechanism for interacting with computing devices that minimizes an amount of time a user is distracted by interactive controls (i.e., so that a user is not endangered while performing concurrent activities, such as driving), yet which permits a user to quickly target a desired item from a potentially large listing of items.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a device that includes audio anchors for directional audio playback from a user designated position.

FIG. 2 is a flow diagram showing a use of audio anchors in accordance with an embodiment of the inventive arrangements disclosed herein.

FIG. 3 is a diagram of an interface for using audio anchors in an interface having vertically arranged and horizontally arranged elements in accordance with an embodiment of the inventive arrangements disclosed herein.

### DETAILED DESCRIPTION OF THE INVENTION

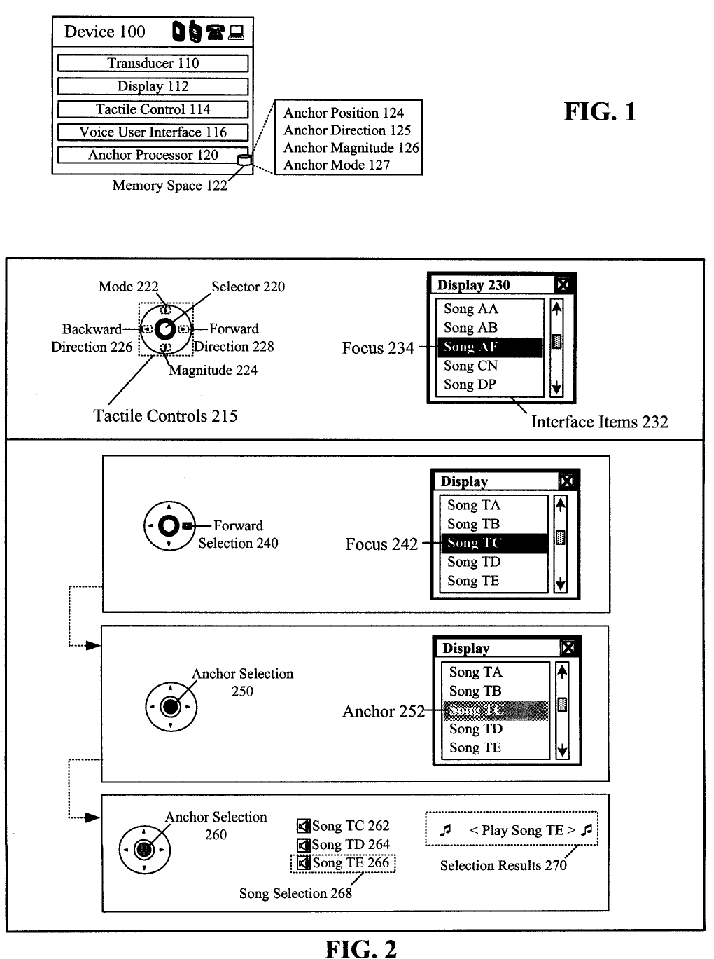

FIG. 1 is a schematic diagram of a device 100 that includes audio anchors for directional audio playback from a user designated position. An audio anchor can be a configurable position in an interface from which interface content is audibly presented. An audio anchor effectively establishes a user configurable point of focus for audio playback purposes. Playback from an audio anchor can be in a forwards direction (i.e., audibly presenting items of an enumerated list from top to bottom starting at the audio anchor), or in a backwards direction (i.e., audibly presenting items of an enumerated list from bottom to top starting at the audio anchor). When playback is for content having horizontally arranged elements as well as vertically arranged ones (i.e., audible playback of a Web page as opposed to a list of items) the forward direction can indicate presenting content from left-to-right and/or from top-to-bottom from the audio anchor. Similarly, the backward direction can play content from right-to-left and/or from bottom-to-top from the audio anchor.

In various contemplated configurations, a rate of playback speed can be adjusted by a user. Further, audio samples can be played (e.g., an audio fast forward or audio reverse capability) to allow a user to quickly skip through audibly played content. When audio fast forwarding capabilities exist, a user can configure a sample duration of playback before skipping to another playback position and/or a distance of each audio skip. Additionally, in one embodiment a direction and speed of playback can be adjusted in proportion to a distance between a playback point and a previously established audio anchor. Thus a skip distance for an audio fast forwarding operation can automatically increase as distance from the audio anchor increases.

As illustrated, the device 100 can include an audio transducer 110, a voice user interface 116, an anchor processor 120 as well as an optional set of tactile controls 114 and an optional display 112. In various embodiments, the device 110 can be a media player, an entertainment system, a mobile phone, a desktop computer, a laptop computer, a navigation system, an embedded computing device, a standalone consumer electronic device, a kiosk, and other such devices.

The audio transducer 110 of device 100 can include a speaker and/or microphone which plays audio output and/or accepts audio input. Audio interactions between a user and the device 100 can occur via the voice user interface (VUI) 116. The VUI 116 can be a voice-only interface or can be a voice interfacing component of a multimodal interface. The display 112 and/or tactile controls 114 can be selectively included in embodiments that visually present content and/or that accept tactile input. The device 100 can also include one or more speech processing components (not shown) or be communicatively linked via a transceiver (not shown) to a speech processing system. The optional speech processing components can include a speech recognition engine for processing received audio input and/or a speech synthesizer for generating speech output from text. Speech output from device 100 need not be output converted from text, but can instead result from a playing of stored audio files that contain encoded speech. Audio anchors can be established and manipulated by the tactile controls 114, by voice commands, and/or by GUI based controls.

The anchor processor 120 can handle operations related to audio anchors, such as establishing audio anchors, removing audio anchors, setting audio anchor parameters, modifying device 110 behavior in accordance with established audio anchor parameters, playing content from an audio anchor, and the like. The anchor processor 120 can utilize one or more configuration parameters 124-127, which can be stored in memory space 122. The configuration parameters can include an anchor position 124, an anchor direction 125, an anchor magnitude 126, an anchor mode 127, and the like.

The anchor position 124 can specify a user established point within content that is to be audibly presented. The anchor direction 125 can indicate whether playback from the anchor point is to be forward, backward, from top-to-bottom, from bottom-to-top, from right-to-left, from left-to-right, and the like. The anchor magnitude 126 can include a rate of playback. The anchor magnitude 126 can also indicate a skipping distance and/or sampling duration for audio fast forwarding operations. The anchor mode 127 can be a configurable mode used to interpret a meaning intended for overloaded operators. For example, if the anchor mode 127 is in an audio fast forwarding configuration, pressing an overloaded tactile control (e.g., a minus sign or a less than arrow) can indicate that a skipping distance is to be decreased. When the anchor mode 127 is in a playback rate configuration, pressing the same control as before (e.g., a minus sign or a less than arrow) can decrease an audio playback rate.

FIG. 2 is a flow diagram showing a use of audio anchors in accordance with an embodiment of the inventive arrangements disclosed herein. The processes shown in FIG. 2 can be performed by a computing device, such as computing device 100, which has been configured to use audio anchors. Throughout the diagram, a set of tactile input controls 215 and a display 230 are used to illustrate concepts of the audio anchor. Controls 215 and display 230 are optional components of a device that uses audio anchors, which only requires a voice user interface that audibly plays back content relative to a user configurable audio anchor. That is, the voice user interface can be an interface of a device having a voice-only modality or the voice user interface can be an interface of a multi-modal device.

In one arrangement, speech processing technologies can use a set of voice commands to establish and utilize audio anchors (as opposed to utilizing controls 215). Any of a variety of different voice commands (e.g., “anchor” for establishing an audio anchor, “faster” for increasing a speaking rate, “slower” for decreasing a speaking rate, “reverse” for changing an enumeration direction, and the like) can be used.

The tactile controls 215 can include any of a variety of controls, such as a main selector 220, a mode control 222, a magnitude control 224, a backward direction control 226, and a forward direction control 228. Each of the controls 215 can be overloaded. The display 230 can include a list of interface items 232. One of the interface items 232 can have focus 234 that can be visually indicated in display 230. The controls 215 and display 230 are to illustrate concepts only and the illustrated arrangement is not to be construed as a limitation of the scope of the device.

For example, in one contemplated embodiment (not shown), the controls 215 can include a Force Sensing Resistor (FSR) region, such as a region of a click wheel control used for many popular media playing devices (e.g., the IPOD). A rate of movement of a finger along the FSR region can determine a speed of a fast-forward or operation and/or a magnitude of a change made to a playback rate. In other embodiments, controls 215 can include a scroll wheel, a rotating dial, a twistable handle, an accelerometer, and the like that can each be used to increase/decrease a playback rate, an enumeration direction, and/or a fast-forward/fast-rewind rate.

FIG. 2 shows that a forward selection 240 can result in the items 232 displayed to be scrolled forward. One of these items (i.e., “Song TC”) can have focus 242. An anchor selection 250 can be made, which establishes Song TC as an audio anchor 252. Once the anchor 252 is established, interface items can be audibly enumerated from that anchor position. For example, assuming that a forward direction is established for the audio anchor, Song TC 262 can be played, followed by song TD 264, followed by song TE 266, and so forth. Another selection of the main selector 260 as the Song TE 266 is being audibly enumerated (shown by song selection 268) can result in a programmatic action executing, where song TE 266 is a required input parameter of the programmatic action. For example, the selection can result 270 in the playing of an audio file corresponding to Song TE.

It should be emphasized that one advantage of the arrangement shown in FIG. 2 is that a user can quickly glance at display 230 and manipulate controls 215 to get “close” to a desired region. When “close”, an audio anchor 252 can be established and a user can listen to audibly enumerated interface items. Thus, an amount of time that a user's attention is focused on a display 230 is considerably less than an amount of time needed to perform a fine grained selection of an exact item. In various scenarios, even the brief time needed to focus on a display 230 to place the audio anchor 252 may be disadvantageous in which case the audio anchor 252 can be positioned based on an exclusive use of speech output. Similarly, speech input can be used instead of input from tactile controls 215 in scenarios where complete hands free operations is advantageous.

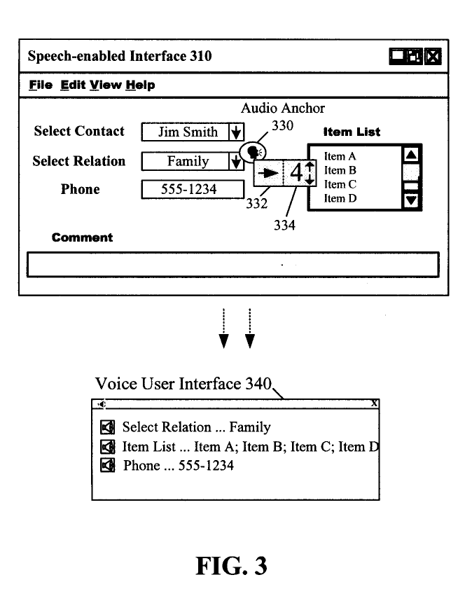

FIG. 3 is a diagram of an interface 310 for using audio anchors in an interface having vertically arranged and horizontally arranged elements in accordance with an embodiment of the inventive arrangements disclosed herein. The interface 310 can be one contemplated interface for device, such as computing device 100, which has been configured to use audio anchors. Elements included in interface 310 are for illustrative purposes only and the invention is not to be construed as limited to details expressed in interface 310.

The interface 310 can include interface items for contacts, relation, phone, an item list, and user comments. An audio anchor 330 can be established near the relation element. An anchor direction 332 of forward and an anchor magnitude 334 of four can be established. The magnitude 334 can indicate a rate of speech playback, which can be adjusted. A forward anchor direction can include that items are to be enumerated from left-to-right and from top-to-bottom starting at the audio anchor 330. Thus, a voice user interface 340 can audibly enumerate “Select relation . . . Family” followed by “Item List . . . Item A; Item B, Item C; Item D” followed by “Phone . . . 555-1234” as shown. If the audio direction 332 were set to backwards, then voice user interface 340 could audibly enumerate “Select Contact . . . Jim Smith.”

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for interfacing with a computing device comprising:
identifying a user established position within an interface of a computing device;
creating an audio anchor at the user established position;
determining an anchor direction setting, wherein said anchor direction setting is a user adjustable setting that includes values of forward playback and backward playback; and
audibly enumerating interface items from the audio anchor in a direction indicated by the anchor direction setting.

2. The method of claim 1, wherein the computing device includes a display screen, said method further comprising:
displaying an indicator of the created audio anchor on the display screen.

3. The method of claim 2, further comprising:
displaying on the display screen a visual indicator showing the anchor director.

4. The method of claim 2, wherein the display screen is a touch screen, said method further comprising:
receiving a touch screen input for an anchor position, wherein the user established position is a position indicated by the touch screen input.

5. The method of claim 2, wherein the computing device further comprises at least one tactile selector, said method further comprising:
displaying a current item of focus upon the display screen;
receiving a tactile input via the at least one tactile selector;
changing the current item of focus responsive to the tactile input, which results in a corresponding change of a displayed item of focus shown in the display screen; and
receiving another tactile input via the at least one tactile selector, wherein the user established position is a position of the changed current item of focus.

6. The method of claim 5, further comprising:
receiving a further tactile input via the at least one tactile selector; and
changing a value of the anchor direction setting responsive to the further tactile input, wherein a playback direction of the enumerating step is a direction established by the changing step.

7. The method of claim 5, further comprising:
establishing a user adjustable anchor playback rate setting, wherein the enumerating step presents audio at a rate specified by the anchor playback rate setting.

8. The method of claim 1, wherein the computing device comprises at least one tactile selector, and wherein the computing device lacks a display screen, said method further comprising:
presenting a indication of a current item of focus, wherein a current item of focus within the interface changes over time; and
receiving a tactile input via the at least one tactile selector, wherein the user established position is a position of the current item of focus at a time at which the tactile input is received.

9. The method of claim 1, further comprising;
receiving a speech input that specifies a position within the interface, wherein the user established position is a position indicated by the speech input.

10. The method of claim 1, wherein the enumerated interface items are an organized list of items.

11. The method of claim 10, wherein the organized list of items are a list of user selectable audio files.

12. The method of claim 11, further comprising:
receiving a user selection as the list of user selectable audio files is being audibly enumerated;
detecting an audio file associated with a most recently audibly enumerated one of the audio files; and
audibly playing the detected audio file.

13. The method of claim 10, further comprising:
receiving a user selection as the list of items is being audibly enumerated;
detecting one of the items that has been most recently audibly enumerated; and
performing a programmatic action wherein the detected one of the items is a required input parameter for the performed programmatic action.

14. The method of claim 1, wherein said steps of claim 1 are performed by at least one machine in accordance with at least one computer program stored in a computer readable media, said computer programming having a plurality of code sections that are executable by the at least one machine.

15. A voice user interface comprising:
a user configurable audio anchor, wherein said audio anchor specifies a starting point for ordered interface item playback; and
a user configurable anchor direction, wherein said anchor direction specifies whether interface items are to be played back in a forward direction or a backward direction relative to the audio anchor.

16. The interface of claim 15, wherein the voice user interface is part of a multimodal interface having a visual display, said interface further comprising:
an audio anchor indicator that is visually presented upon the visual display to indicate a location of the audio anchor.

17. The interface of claim 15, further comprising:
at least one tactile control, wherein said at least one tactile control is used to establish the audio anchor at a user selected position.

18. The voice user interface of claim 15, further comprising:
a user configurable anchor magnitude, wherein said anchor magnitude specifies a rate of audio playback of ordered interface items.

19. The voice user interface of claim 15, wherein the interface is an interface of a media playing device, and wherein the interface items are songs.
